(19) United States
(12) Patent Application Publication
(10) Pub. No.: US 2010/0229183 A1
(43) Pub. Date: Sep. 9, 2010

(54) FRAMEWORK DEVICE OF MOBILE TERMINAL AND METHOD FOR PROVIDING INTEROPERABILITY BETWEEN COMPONENTS

(75) Inventors: Myung Nam Bae, Daejeon (KR); Byung Bog Lee, Daejeon (KR); Ae-Soon Park, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignees: SAMSUNG ELECTRONICS CO., LTD., Suwon-Si, Gyeonggi-Do (KR); ELECTRONICS AND TELECOMMUNICATIONS RESEARCH INSTITUTE, DAEJEON (KR)

(21) Appl. No.: 12/738,165

(22) PCT Filed: Aug. 21, 2008
(86) PCT No.: PCT/KR08/04885

§ 371 Date: Apr. 15, 2010

(30) Foreign Application Priority Data
Oct. 17, 2007 (KR) 10-2007-0104481

(51) Int. Cl. G06F 9/46; G06F 13/14

(52) U.S. Cl. 719/315; 710/305

(57) ABSTRACT

The present invention relates to a framework device of a mobile terminal and a component interoperability guaranteeing method, and is configured by a hardware component generated by a developer and hardware middleware to be linked by a software (or another hardware) component. Therefore, in the exemplary embodiment of the present invention, hardware dependent parts in the hardware component are provided to the hardware middleware through setting parameters so that the hardware middleware is linked with the corresponding hardware component. The hardware middleware receives a request message according to the general inter-ORB protocol (GIOP) transmission system used for the basic communication system of the framework, parses the request message, and converts and transmits data to the corresponding hardware component. The hardware component (hardware logic) to which the request message is transmitted uses data to perform its unique function, and the result is configured as a response message by the hardware middleware and is then transmitted to the software component.

### TECHNICAL FIELD

The present invention relates to a framework device of a mobile terminal and a method for guaranteeing interoperability between components. Particularly, the present invention relates to a framework device of a mobile terminal and a method for guaranteeing interoperability of components for guaranteeing interoperability between a hardware component and a software component by a framework of a mobile terminal.

This work was supported by the IT R&D program of MIC/IITA [2005-S-404-33, Research and Development Mobile Terminal Technology based on 3G Evolution].

### BACKGROUND ART

The software communication architecture (SCA), which is a mobile terminal framework, was proposed by the joint tactical radio system (JTRS) and the joint program executive office (JPEO), and it is a software system for communication for providing software portability and guaranteeing software reconfiguration performance. The software communication architecture (SCA) is based on the common object request broker architecture (CORBA), which is the industrial standard for the distributed object models. The CORBA represents middleware for providing independency for the communication system, development language, and operating system during the component development process.

Currently, general purpose processors (GPP) are being substantially developed, and many components in a mobile terminal are realized with field programmable devices (FPD) such as a field programmable gate array (FPGA) or a complex programmable logic device (CPLD). The FPD allows real-time processing, and processes a plurality of complicated algorithms in parallel. However, in the mobile terminal framework such as the software communication architecture (SCA), the hardware component is realized depending on chips or boards for individual venders, and it is difficult for the software component of the general purpose processor (GPP) to be individually and directly interoperable with the hardware components of the FPD. This is because the mobile terminal's hardware environments are diversified, and linking methods with the hardware components are respectively different. Therefore, interoperability for the mobile terminal is not allowed and the re-use rate is substantially reduced.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide a framework device of a mobile terminal for guaranteeing interoperability between components, and a method for guaranteeing interoperability of components.

### Technical Solution

An aspect of the present invention provides a framework device including a software component, an object request broker, a plurality of hardware components, and hardware middleware. The software component realizes an application, the object request broker provides a logic communication path to the software component, the hardware components include a plurality of hardware logics for performing input data, and the hardware middleware supports the object request broker and a standard transmission system to receive a request message from the software component, selects a first hardware logic for performing data included in the request message from among the plurality of hardware logics of the plurality of hardware components, and converts the data included in the request message into first data to transmit the first data to the first hardware logic, and the hardware middleware is connected through the plurality of hardware components and a common bus structure.

Another aspect of the present invention provides a method for guaranteeing interoperability of components in a framework device of a mobile terminal including a plurality of hardware components including a plurality of hardware logics and a plurality of software components. The method includes: receiving a request message including an object identifier and an operation title from the software component; selecting a hardware component corresponding to the object identifier from among the plurality of hardware components; selecting a first hardware logic corresponding to the operation title from among the plurality of hardware logics of the selected hardware component; converting the data into first data, and transmitting the first data to the first hardware logic through a common bus structure connected to the plurality of hardware components; and performing the first data to the first hardware logic.

### Advantageous Effects

In the exemplary embodiment of the present invention, hardware component's hardware dependent part is realized into hardware middleware so that interoperability between the hardware component and the software component is guaranteed irrespective of the location of the components, and real-time processing and QoS improvement effects, which are utilization targets of the hardware component, are increased. Also, a hardware dependent part is solved through the hardware middleware, and hence reuse of the hardware component is increased.

### BRIEF DESCRIPTION OF THE DRAWINGS

FIG. 1 shows a framework device of a mobile terminal according to an exemplary embodiment of the present invention.

FIG. 2 shows a hardware middleware development flowchart according to an exemplary embodiment of the present invention.

FIG. 3 shows a schematic diagram of hardware middleware according to an exemplary embodiment of the present invention.

FIG. 4 shows a configuration diagram of a logic apply signal used for a common bus structure according to an exemplary embodiment of the present invention.

FIG. 5 shows a schematic diagram of a hardware component according to an exemplary embodiment of the present invention.

FIG. 6 and FIG. 7 show a method for realizing the attributes shown in Table 1.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Through the specification, unless explicitly described to the contrary, the word “comprise” and variations such as “comprises” or “comprising” will be understood to imply the inclusion of stated elements but not the exclusion of any other elements. In addition, the terms “-er”, “-or” and “module” described in the specification mean units for processing at least one function and operation, and can be implemented by hardware components or software components and combinations thereof.

A framework device of a mobile terminal and an interoperability guaranteeing method of components according to an exemplary embodiment of the present invention will be described with reference to the accompanying drawings.

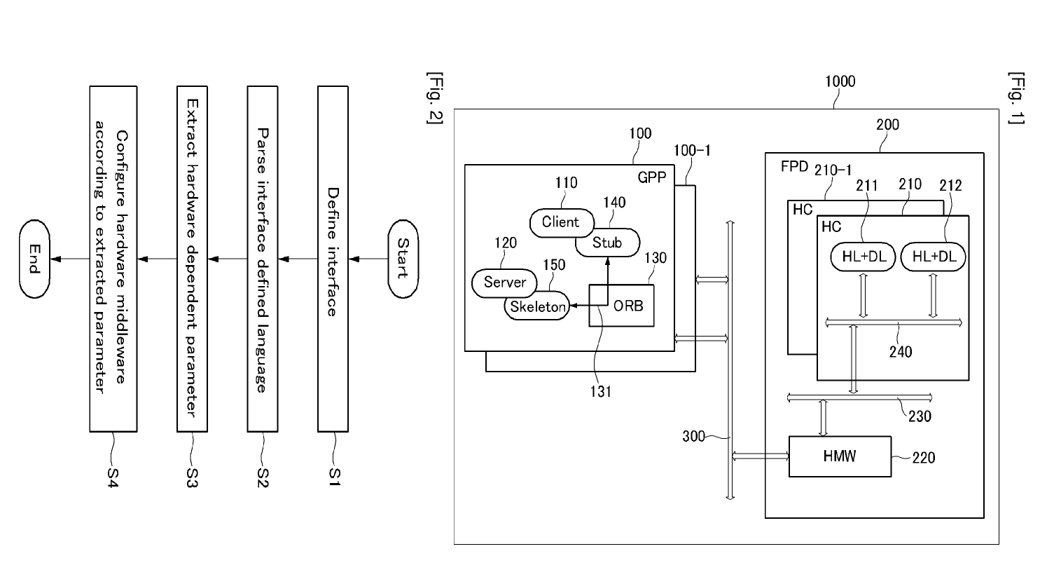

FIG. 1 shows a framework device of a mobile terminal according to an exemplary embodiment of the present invention.

As shown in FIG. 1, the framework 1000 of a mobile terminal includes a plurality of general purpose processors (GPP) (100, 100-1), a field programmable device (FPD) 200, and a system bus 300 for connecting the general purpose processors (100, 100-1) and the FPD 200.

The general purpose processor 100 includes a plurality of software components, and for ease of description, a client 110 and a server 120 will be exemplified from among the software components. The FPD 200 includes a plurality of hardware components, and for convenience, two hardware components (210, 210-1) will be exemplified. The hardware component 210 includes a plurality of hardware logics (i.e., hardware logic+developer logic (HL+DL), and for convenience of description, two hardware logics 211 and 212 will be described.

The general purpose processor 100 includes a client 110, a server 120, an object request broker (ORB) 130, a stub 140, and a skeleton 150.

The client 110 is a typical software component for realizing an application by using a service of the server 120. The server 120 is a software component corresponding to service realization for processing a request by the client 110.

The object request broker 130 provides a software bus 131 that is a logical communication path to the client 110 and the servers 120 that are provided in the same general purpose processor 100 or another general purpose processor 100-1. A physical communication path for the software bus 131 in the single general purpose processor 100 is realized by a socket or a shared memory method between processors. A physical communication path for the software bus 131 between the different general purpose processors (100, 100-1) is realized by an inter-processor transfer system (e.g., Ethernet or a shared memory between processors).

The stub 140 and the skeleton 150 provide an interface for linkage between the software components 110 and 120 through the software bus 131. In detail, they include a byte order (data endian), an address alignment (address align), and transmission message composition/analysis.

The FPD 200 includes hardware components (210, 210-1), hardware-based middleware 220, a common bus structure 230, and a local bus structure 240.

The hardware component 210 includes a set of hardware logic (HL+DL) 211 and 212 having realized the algorithm to be performed in the FPD 200. The hardware logics 211 and 212 are directly used by a mobile terminal for the purpose of real-time processing, various utilization of hardware resources, and QoS improvement, and they are coded by the hardware description language (HDL) such as the VHSIC hardware description language (VHDL). In this instance, the hardware logics 211 and 212 are identified by the hardware middleware 220, and perform their function by using the received message. In the viewpoint of the mobile terminal framework, the hardware logics 211 and 212 are those generated by realizing operation of the software components in the framework.

The hardware middleware 220 transmits/receives a message with the external unit of the FPD 200 through the general inter-ORB protocol (GIOP) that is the standard common object request broker architecture (CORBA) communication protocol. In this instance, the hardware middleware 220 parses the received GIOP_request message to identify the hardware components (210, 210-1) for performing the request. The hardware middleware 220 converts the parameter data included in the received GIOP_request message if necessary, and transmits it to the hardware components (210, 210-1).

The hardware middleware 220 is reconfigurable according to setting parameters, and is developed as shown in FIG. 2.

FIG. 2 shows a hardware middleware development flowchart according to an exemplary embodiment of the present invention.

A software developing person and a hardware developing person define the interface based on the request and response irrespective whether the software components 110 and 120 are provided to the general purpose processor 100 or the FPD 200 (S1). Definition of the interface uses the standard interface definition language (IDL). The software developing person and the hardware developing person parse the interface definition language (IDL) through an additional interface parser (not shown) (S2). The interface parser extracts a hardware dependent parameter from the component and a parameter to be linked with the hardware logic 211 of the individual hardware component 210 from the hardware middleware 220 (S3). The hardware middleware is reconfigured according to the parameters (setting parameters) extracted by the interface parser (S4).

The common bus structure 230 connects the hardware middleware 220 and the hardware components (210, 210-1). The local bus structure 240 connects the individual hardware logics 211 and 212 in the hardware components (210, 210-1), and includes a common bus structure 230. When there are data to be shared with another hardware logic in the hardware component 210, the data are added to the common bus structure 230. The local bus structure 240 is redefined as a proper local bus structure 240 of the individual hardware logics 211 and 212. The developing person developing the hardware logics 211 and 212 directly determines the extension range according to the context to be performed by the hardware logics 211 and 212.

The hardware logics 211 and 212 convert the interface definition language (IDL) into the VHDL as shown in Table 1 in order to perform the actual service.

TABLE 1

| IDL | VHDL |
|---|---|
| Interface | Entity (A) |
| Attributer | Register or Entity (Sub-entity of A) |
| Operation | Entity (Sub-entity of A) |

The “Interface” in the interface definition defined during the development process of the hardware middleware 220 is converted into the “entity” of the VHDL, and is included in the hardware component 210. The “operation” is converted into a sub-“entity” and is converted into one or two sub-“entities” according to the input/output formats (in, out, in-out) of the parameter, and the converted entities are respectively included in the hardware logics 211 and 212. The “attribute” is converted into a sub-“entity” for controlling a register in the “entity” or an independent memory block. The converted hardware description language is compiled and synthesized by a tool of synthesizing the hardware description language, and is then downloaded to the FPD 200.

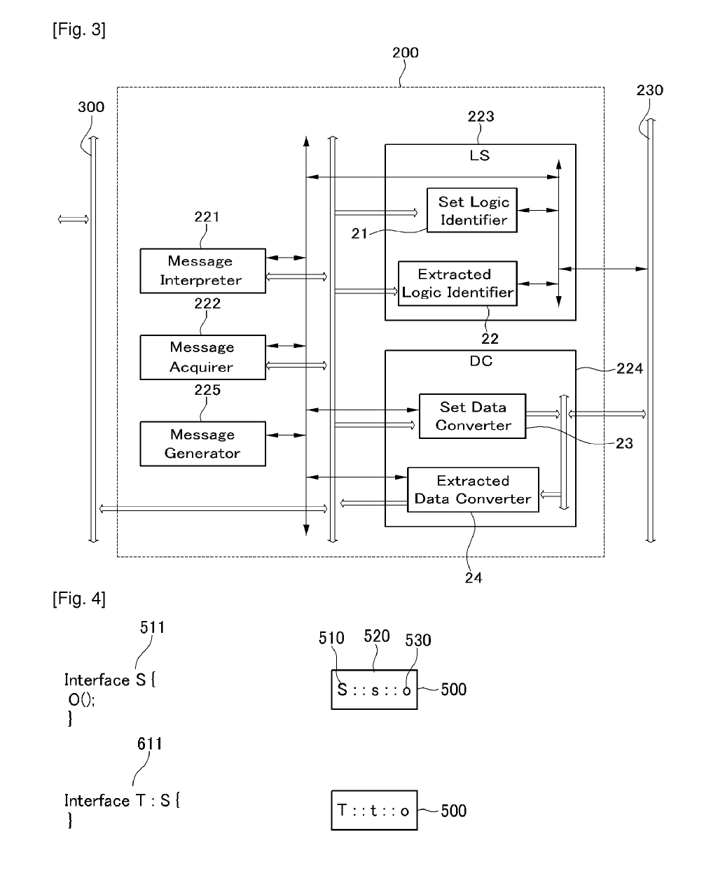

FIG. 3 shows a schematic diagram of hardware middleware 220 according to an exemplary embodiment of the present invention.

The hardware middleware 220 applies (enables) the hardware logics 211 and 212 for performing the message according to the GIOP_request massage of the client 110 input through the system bus 300, and controls the whole process for a response. The hardware middleware 220 receives a request message from the external object request broker 130 through the GIOP transmission system. Since the received request message is transmitted through the system bus 300, all the request messages are buffered into an external storage unit (generally a RAM shared by the general purpose processor). The hardware middleware 220 extracts a request message from the external storage unit according to the first-in first-out (FIFO) rule. In this instance, parameters including the size of the system bus 300, address allocation, external storage unit information, and a number of required hardware middleware are provided to the hardware middleware 220. The hardware component does not depend on the condition change of the parameters.

The configuration of the request message input to the hardware middleware 220 is expressed in Table 2.

TABLE 2

| Message header | | | Message body | | | |
|---|---|---|---|---|---|---|
| message | response | length | request | object | operat- | data |
| informat- | state | | identifier | identifier | ion | |
| ion | | | | | title | |

Referring to Table 2, the “object identifier” in the request message is used to identify the hardware component 210, and the “operation title” (title of “operation” in Table 1) is used to specify specific hardware logics 211 and 212 in the hardware component 210. The “data” are data required for performing the hardware logics 211 and 212 (parameters to be used by the “operation” in Table 1). The “request identifier” is used to identify the response message when the hardware middleware 220 transmits a result in response to the request message. The “response state” is used to indicate whether to request a response to the request message or not.

The interoperable object reference (IOR) is an identifier for identifying all connectable software components 110 and 120. The client 110 acquires an “object identifier” from the IOR of the server 120 to be requested. However, since the hardware middleware 220 in the FPD 200 can detect the generation state/number of hardware components (210, 210-1), the object identifier between the hardware middleware 220 and the hardware components (210, 210-1) are configured as Table 3.

TABLE 3
object identifier area

| | |
|---|---|
| interface identifier | instance identifier |

The “interface identifier” is configured by a bit sequence having the number of the entire hardware components (210, 210-1) activated for the FPD 200 as a range, and the “instance identifier” is configured by a bit sequence having the maximum repeated number of the hardware components (210, 210-1) as a range. The size and the generation rule of the minimized object identifier are provided as parameters to the hardware middleware 220. For example, when two repeated generations of the 8 “interfaces” are allowed in the definition of the interface, the object identifier of Table 3 is set to have 5 bits. In this instance, when no repeated generation is allowed to the “interface”, the object identifier of Table 3 is set to have 4 bits. Accordingly, the hardware middleware 220 configures the object identifier according to the number of hardware components (210, 210-1) to thus optimize the common bus structure 230 for connecting the hardware components (210, 210-1) and the hardware middleware 220.

As shown in FIG. 3, the hardware middleware 220 includes a message interpreter 221, a message acquirer 222, a logic selector (LS) 223, a data converter (DC) 224, and a message generator 225.

The message interpreter 221 determines the request message provided from the outside as shown in Table 2. In this instance, the “data” are byte aligned (endian) and address aligned by common data representation (CDR). The message acquirer 222 determines the “length” from among the message header of the request message and divides the request message according to a predetermined length to acquire it.

The logic selector 223 identifies the hardware components (210, 210-1) according to the “object identifier” included in the request message, and determines the hardware logics 211 and 212 for realizing the real “operation” function by using the “operation title” included in the request message. In further detail, the logic selector 223 generates a numerical “operation identifier” from the “operation title”, combines the “operation identifier” and the “object identifier”, and generates an “apply signal”. In this instance, the apply signal determines the hardware logics 211 and 212 for realizing the real target service. The parameters including the size of the apply signal and the size of the maximum operation title are generated by the interface parser, and provided to the hardware middleware 220 so as to be optimized.

The set logic identifier 21 selects the corresponding hardware logic, designated by the operation title in the request message from among a plurality of hardware logics 211 and 212, as a set logic, and transmits an apply signal by using the set logic to thus apply a set logic. The apply signal will be assumed to determine the first hardware logic 211 as a set logic for convenience of description. When the apply signal determines the first hardware logic 211 as a logic, the data converter 224 extracts the parameter required by the first hardware logic 211 from among the data in the request message. The data aligned by the message interpreter 221 include a plurality of padding data, and a process for removing the padding data is needed. Therefore, when the apply signal determines the first hardware logic 211 as a set logic, the set data converter 23 of the data converter 224 reduces the data input by the message interpreter 221 to be the minimum size of parameter data. This process is required so as to minimize the usage amount for the restricted resource (bus and multiplexor) of the FPD 200. The reduced parameter data are transmitted to the first hardware logic 211 through the common bus structure 230. In this instance, the data or the signal transmitted through the common bus structure used by the first hardware logic 211 is expressed in Table 4.

TABLE 4

| contents | size |
|---|---|
| logic apply signal | object identifier + operation identifier (bit unit) |
| reduced parameter data | size sum of parameter (bytes) |

Referring to Table 4, the “object identifier” and the “operation identifier” are based on the bits, and are common to all “logic apply signals”. The “reduced parameter data” are the sum of the entire parameters based on the bytes, and the reducing process is performed by the set data converter 224. In this instance, the parameters such as the “reduced parameter data” are parsed by the interface parser and are then provided to the hardware middleware 220.

When a request message requesting a response is input, an extracted logic identifier 22 selects the hardware logic corresponding to the operation title of the request message as an extracted logic from among a plurality of hardware logics 211 and 212, transmits an apply signal by using the extracted logic, and applies the extracted logic. For convenience of description, the apply signal will be assumed to determine the second hardware logic 212 to be an extracted logic. When the apply signal determines the second hardware logic 212 as an extracted logic, the data converter 224 receives the data prepared by the extracted logic through the common bus structure 230. In this instance, the data or signal transmitted through the common bus structure used by the extracted logic is expressed in Table 5.

TABLE 5

| contents | size |
|---|---|
| logic apply signal | object identifier + operation identifier (bits) |
| receiving allowed signal | 1 bit |
| data to be received | size sum of data (bytes) |

The “logic apply signal” in Table 5 corresponds to that in Table 4. The “receiving allowed signal” is a control signal for notifying the case when the extracted logic is prepared to transmit data. An extracted data converter 24 of the data converter 224 extensively converts the “data to be received” into data following the common data representation (CDR). The data converted by the extracted data converter 24 are transmitted to the message generator 225. In this instance, the parameters such as the size of the common bus structure 230 to be used for transmitting the “data to be transmitted” are provided to the hardware middleware 220 by the interface parser.

The message generator 225 includes the data input by the data converter 224 in the response message to generate a response message appropriate for the GIOP transmission system. The generated response message is transmitted to the external object request broker 130 through the system bus 300. In this instance, the “request identifier” shown in Table 2 is added.

FIG. 4 shows a configuration diagram of a logic apply signal used for a common bus structure 230 according to an exemplary embodiment of the present invention.

When power is supplied to the FPD 200, the hardware components (210, 210-1) and the hardware logics 211 and 212 are simultaneously activated. However, in the FPD 200, the hardware logics 211 and 212 having received an apply signal from the logic selector 223 of the hardware middleware 220 is performed. In this instance, a unique apply signal number is respectively assigned to the hardware logics 211 and 212 of the FPD 200 by the interface parser. Further, the hardware logics 211 and 212 following the inheritance hierarchy can be overridden according to inheritance of the interface definition language (IDL). For this, an apply signal 500 of the hardware logics 211 and 212 is specified by division of an interface division area 510, an instance division area 520, and a logic division area 530. The interface division area 510 is used to divide the interface 511 from the interface definition language (IDL). The instance division area 520 is used to divide the hardware components (210, 210-1) when repeating and processing them in parallel. The logic division area 530 divides the operation title 531 in the inheritance hierarchy. The above-noted areas are provided to the hardware middleware 220 by the interface parser. The interface S 511 and the interface T 611 have an inheritance relation, and the interface S 511 is an upper interface of the interface T 611, and the interface T 611 can accept the characteristic of the interface S 511. In the drawing, the apply signal 500 and the apply signal 600 indicate the same operation (here, o( )). The apply signal 500 and the apply signal 600 have different signal values, and indicate the same hardware logic in consideration of the inheritance hierarchy. Recognition thereof and selection of the hardware logic to be applied are performed by the logic selector 223. The hardware logics 211 and 212 generate a single logic division identifier to the hardware logic that is overridden in the inheritance relation, and provide it as a parameter to the hardware middleware 220.

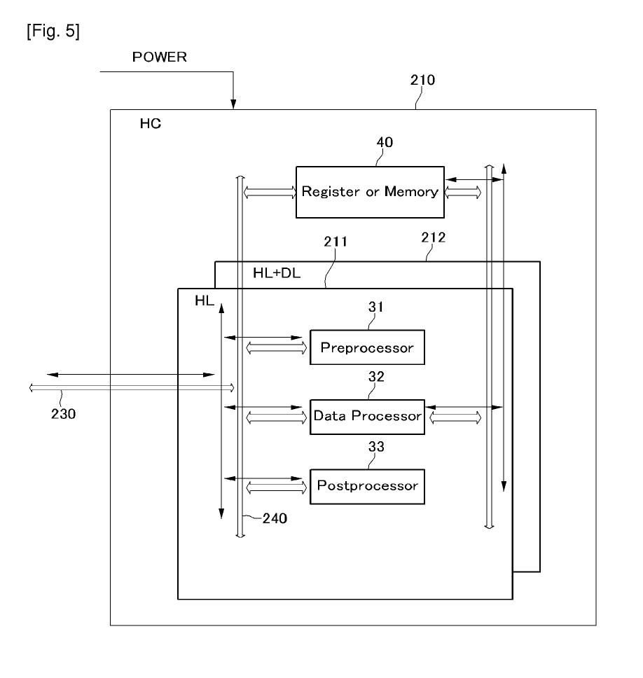

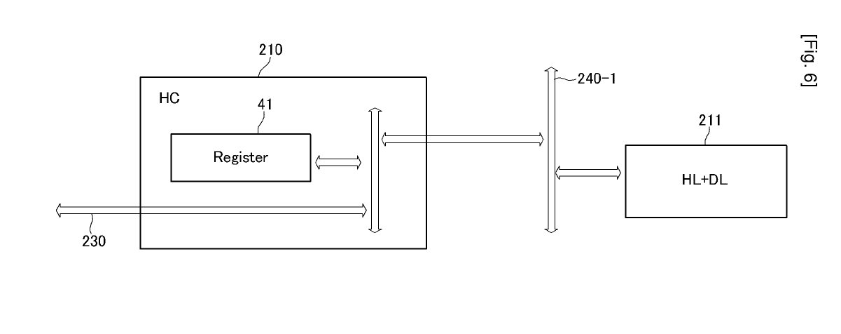

FIG. 5 shows a schematic diagram of a hardware component according to an exemplary embodiment of the present invention.

The hardware component 210 includes a plurality of hardware logics 211 and 212, and a register/memory 40.

The register/memory 40 controls a plurality of hardware logics 211 and 212 to share the “attribute” in the hardware component 210, and if necessary, it generates a template logic for using the register/memory 40.

The hardware component 210 has the hardware logics 211 and 212 corresponding to the operations declared in the interface as lower components (described with reference to Table 1). The data that are received through the common bus structure 230 are reduced by bytes (described with reference to Table 2).

The hardware logic 211 includes a preprocessor 31, a data processor 32, and a postprocessor 33.

The preprocessor 31 converts the byte-based data (described with reference to Table 2) input through the local bus structure 240 into signal data to be processed by the data processor 32. The data processor 32 is performed together with the input signal data. When the performance of the data processor 32 is finished, the postprocessor 33 converts the signal data into data that is appropriate for the common bus structure 230. In this instance, the data processor 32 represents realization of a service from the viewpoint of the hardware described by a hardware developing person.

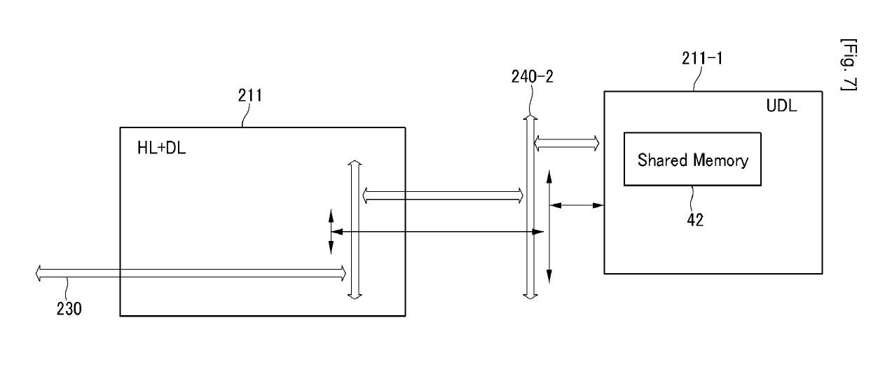

FIG. 6 and FIG. 7 show a method for realizing the attributes shown in Table 1.

FIG. 6 shows a method used for simplifying realization with a lesser size of the “attribute”. The “attribute” in this case is converted into a register 41 in the hardware component 210, that is, an entity for the “interface”. The hardware logic 211 that is an operation entity using the register 41 in the hardware component 210 is redefined by adding the register 41 to a local bus 240-1.

FIG. 7 shows a method for representing the “attribute” as a shared memory 42 and positioning its process on the user-defined developer logic (UDL) 211-1. The hardware logic 211 that is an “operation” entity for sharing the “attribute” additionally has a user defined bus 240-2 for connection with the UDL 211-1. When the HC 210 has no register 41 as shown in FIG. 7, the hardware logic 211 is directly connected to the common bus structure 230.

Accordingly, the exemplary embodiment of the present invention is configured by the hardware component generated by the developing person and hardware middleware to be linked as a software (or another hardware) component. Therefore, in the exemplary embodiment of the present invention, hardware dependent parts in the hardware component are provided to the hardware middleware through the setting predetermined parameters, and hence, the hardware middleware can be linked with the corresponding hardware component.

The hardware middleware receives the request message according to the GIOP transmission system used in the basic communication system of the framework, parses the request message, and transmits converted data to the corresponding hardware component. The hardware component (hardware logic) to which the request message is transmitted performs appropriate functions by using the data, the corresponding result is configured to be a response message by the hardware middleware, and the response message is transmitted to the software component.

In the exemplary embodiment of the present invention, the hardware possessed by the hardware component and the mobile terminal framework dependent parts are configured as hardware middleware to thus eliminate the dependency on the hardware component or the mobile terminal framework. As a result, data communication between the hardware component and the software component is allowable and the communication system is provided without depending on the hardware or mobile terminal framework. Therefore, interoperability between the hardware component and the software component is guaranteed. Further, reuse of the hardware component is increased since the hardware dependent parts in the framework of the mobile terminal are solved through the hardware middleware.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A framework device comprising:
a software component for realizing an application;
an object request broker for providing a logic communication path to the software component;
a plurality of hardware components including a plurality of hardware logics for performing input data; and
hardware middleware for supporting the object request broker and a standard transmission system to receive a request message from the software component,
selecting a first hardware logic for performing data included in the request message from among the plurality of hardware logics of the plurality of hardware components, and converting the data included in the request message into first data to transmit the first data to the first hardware logic, the hardware middleware being connected through the plurality of hardware components and a common bus structure.

2. The framework device of claim 1, wherein
the request message includes:
an object identifier for identifying a selected hardware component;
an operation title specifying the first hardware logic;
data to be performed in the first hardware logic; and
a request identifier for identifying the response message.

3. The framework device of claim 2, wherein
the object identifier includes:
an interface identifier having a bit sequence having a number of the plurality of hardware components as a range; and
an instance identifier having a bit sequence having the maximum repeated number of the plurality of hardware components as a range.

4. The framework device of claim 2, wherein
the hardware middleware includes:
a message interpreter for determining the request message;
a logic selector for generating a first apply signal for identifying the hardware component according to the object identifier included in the request message,
generating an operation identifier from the operation title, combining the operation identifier and the object identifier, and determining the first hardware logic; and
a data converter for extracting a parameter used for performing the first hardware logic from the request message, converting the parameter into first data, and transmitting the first data to the first hardware logic through the common bus structure.

5. The framework device of claim 4, wherein
the data converter includes a set data converter for reducing the parameter into the first data that is the minimum-sized parameter, and transmitting the first data to the first hardware logic through the common bus structure.

6. The framework device of claim 4, wherein
when a response to the request message is needed, the logic selector generates a second apply signal for determining a second hardware logic as an extract logic from among the plurality of hardware logics.

7. The framework device of claim 6, wherein
the data converter further includes an extracted data converter for converting the second data received from the second hardware logic through the common bus structure, and
the hardware middleware further includes a message generator for generating a response message from the converted second data, and transmitting the response message to the software component through the object request broker.

8. The framework device of claim 6, wherein
when a response to the request message is needed, the second apply signal, which is a logic apply signal for notifying the case in which data transmission is prepared in the second hardware logic, and the second data received from the second hardware logic, are transmitted through the common bus.

9. The framework device of claim 1, wherein
the hardware component further includes a local bus structure for individually connecting the plurality of hardware logics.

10. The framework device of claim 1, wherein
the hardware logic includes:
a preprocessor for receiving the first data from the hardware middleware, and
converting the first data into signal data performed by the hardware logic;
a data processor for processing the signal data; and
a postprocessor for converting the signal data processed by the data processor into data appropriate for the common bus structure.

11. The framework device of claim 10, wherein
the hardware logic further includes a register/memory for sharing attributes so that the plurality of hardware logics may share the attributes.

12. A method for guaranteeing interoperability of components in a framework device of a mobile terminal including a plurality of hardware components including a plurality of hardware logics and a plurality of software components, the method comprising:
receiving a request message including an object identifier and an operation title from the software component;
selecting a hardware component corresponding to the object identifier from among the plurality of hardware components;
selecting a first hardware logic corresponding to the operation title from among the plurality of hardware logics of the selected hardware component;
converting the data into first data, and transmitting the first data to the first hardware logic through a common bus structure connected to the plurality of hardware components; and
performing the first data to the first hardware logic.

13. The method of claim 12, wherein
the selecting of the first hardware logic includes:
generating an operation identifier from the operation title, combining the operation identifier and the object identifier, and generating a first apply signal for determining the first hardware logic as a set logic; and
applying the first apply signal to the first hardware logic.

14. The method of claim 12, wherein
the transmitting of the first data includes:
extracting a parameter used for performing the first hardware logic from the request message; and
reducing the parameter into the first data.

15. The method of claim 12, wherein
the performing includes:
converting the first data into signal data performed in the first hardware logic;
performing the signal data in the first hardware logic; and
converting the performed signal data into data that is appropriate for the common bus structure.

16. The method of claim 12, further comprising:
when a response to the request message is needed, generating a second apply signal for determining a second hardware logic from among the plurality of hardware logics as an extract logic;
receiving second data from the second hardware logic through the common bus structure; and
generating a response message to be transmitted to the software component by converting the second data.
